(19) United States
(12) Patent Application Publication
(10) Pub. No.: US 2004/0006454 A1
(43) Pub. Date: Jan. 8, 2004

(54) System and method for modeling digital systems having queue-like operating characteristics

(75) Inventor: Paul Caprioli, Mountain View, CA (US)

Correspondence Address: David B. Ritchie, Thelen Reid & Priest LLP, P.O. Box 640640, San Jose, CA, 95164, US

(73) Assignee: Sun Microsystem, Inc., Delaware Corporation

(21) Appl. No.: 10/185,499

(22) Filed: Jun. 27, 2002

(51) Int. Cl. G06F 17/50

(52) U.S. Cl. 703/16

(57) ABSTRACT

The invention is directed to a method and apparatus for simulating a digital logic circuit simulator. In particular, a block object, representing a component of the digital logic circuit, is instantiated. An event object having a queue is also instantiated. The queue holds an ordered list of destinations, which are representative of the block objects that the event object initiates an action with. When the event object interacts with the block object, this initiates behavior in the block object indicative of behavior of the component in the digital system. The digital logic circuit simulator components, namely the block object and the event object, can be instantiated in a run-time object oriented language, such as the JAVA® language promulgated by Sun Microsystems. The block object can initiate a dynamic addition to the destination queue. Additionally the destination can be another event object. When the destination is another event object, another event object is initiated. The new event object may be dynamically created within the instructions of adding to the destination queue, and may based upon test for the existence of a particular condition. The event object can alter a condition of the block object, and vice versa. As such, a system and method for simulating event behavior in a complex digital system is envisioned. Other objects, advantages and novel features of the present invention will be apparent to those skilled in the art from the following detailed description of the invention, the appended claims, and in conjunction with the accompanying drawings.

### FIELD OF THE INVENTION

This invention relates to simulation and design of digital circuitry. More particularly, it relates to a system and method of simulating digital systems in a software environment.

### DESCRIPTION OF THE PRIOR ART

Digital circuitries typically exhibit more degrees of complex behavior as the complexity of the system grows. All the same, timing considerations, event flow, and system resource allocation in this arena all are important considerations.

Current microprocessors contain vast numbers of more highly defined logical, or block level, systems. On a less macroscopic level, these complex systems contain hundreds of millions of elements making up these block level components. These block and smaller level systems are all responsive to events. Many different types of events are serviced, and generated by these components.

For example, a floating point unit may pipeline many macro level instructions. In this sense, the instructions may be serviced with different timing considerations, based on the state of the machine, and the type of request.

The same floating point unit may also contain different queues within itself, each queue responsible for the performance of one low level operation. These different queues may be all interlinked to perform the higher order instruction, but the output of the queues may be dependent upon different things, including the availability of system resources, the result of another queue, or if the larger component had to respond to some external request.

The functionality of the unit, as a queue may be altered during runtime in light of some pre-engineered behavior. Additional individual sub-components exhibiting queue-like behavior may also be similarly altered. This behavior can include such designs as “look-ahead” type instruction behavior, prefetch behavior, or the like.

System resources can impact seriously on the queue behaviors as well. For example, a multilevel cache may be present. In this case, the queue behavior is dependent on the contents of the different order caches, and whether the data needs to be pulled in from slower but more persistent data storage systems.

In the case of many processors, these behaviors are duplicated many times. This is due to the sheer number of logical components that the typical microprocessor must use or employ. However, many computer systems use multiple processor systems. Thus, the interaction between the processors themselves leads to many event processing scenarios just to take into account the interactions between the processors. This is above and beyond the requirements for the processors themselves.

Additionally, many systems have many multi-processor boards coupled through multiple interconnecting busses in various configurations. In this manner, the interactions grow even larger. Especially so in the event that each processor may maintain a cache, or several caches. When other processors attempt to access data, the data may be in another cache under the control of a different processor, and subject to varying levels of control. In this manner, the interactive requests between the processors regarding data control and coherency involve increasingly complex behavior.

Accordingly, the simulators that model these highly complex systems are themselves highly complex. As can be seen, the numbers of components, interactions, external events, and internal events is quite high.

### SUMMARY OF THE INVENTION

The invention is directed to a method and apparatus for simulating a digital logic circuit simulator. In particular, a block object, representing a component of the digital logic circuit, is instantiated. An event object having a queue is also instantiated. The queue holds an ordered list of destinations, which are representative of the block objects that the event object initiates an action with. When the event object interacts with the block object, this initiates behavior in the block object indicative of behavior of the component in the digital system. The digital logic circuit simulator components, namely the block object and the event object, can be instantiated in a run-time object oriented language, such as the JAVA® language promulgated by Sun Microsystems. The block object can initiate a dynamic addition to the destination queue. Additionally the destination can be another event object. When the destination is another event object, another event object is initiated. The new event object may be dynamically created within the instructions of adding to the destination queue, and may based upon test for the existence of a particular condition. The event object can alter a condition of the block object, and vice versa. As such, a system and method for simulating event behavior in a complex digital system is envisioned. Other objects, advantages and novel features of the present invention will be apparent to those skilled in the art from the following detailed description of the invention, the appended claims, and in conjunction with the accompanying drawings.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a computing device operating a digital logic simulator according to the invention.

FIGS. 2-4 depict an embodiment of the simulator of FIG. 1. In this case, the simulator initiates the event objects 202 and 204.

FIGS. 5 and 6 are block object oriented diagrams detailing the timing characteristics of various block diagrams.

FIG. 7 is a block diagram detailing the interactions that event objects, block objects, and system wide values may have on one another.

FIGS. 8-10 are a block level diagram of another embodiment of the system of FIG. 1.

FIGS. 11 through 15 are block diagrams indicating another aspect of the invention of FIG. 1.

FIG. 15 is an exemplary implementation of a high level simulation of a multi processor, multi-bus system that can be simulated with the present invention.

### DETAILED DESCRIPTION OF THE PREFERRED EMBODIMENT

Embodiments of the present invention are described herein in the context of a SYSTEM AND METHOD FOR MODELING DIGITAL SYSTEMS HAVING QUEUE-LIKE OPERATING CHARACTERISTICS. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.}

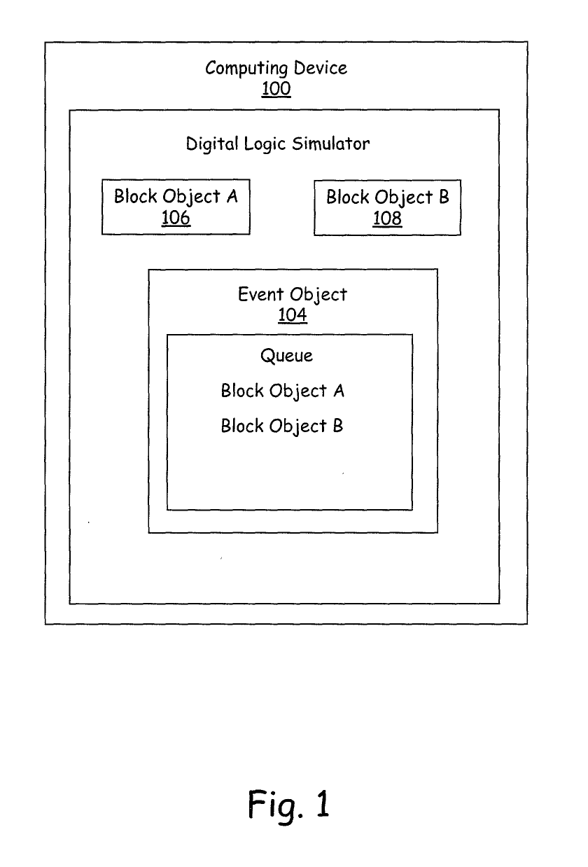

FIG. 1 is a block diagram of a computing device operating a digital logic simulator according to the invention. In particular, the computing device 100 contains a software based digital logic simulator 102. The digital logic simulator 102 incorporates an event object 104, and the block objects 106 and 108.

The block objects are modules that model components of the digital system. For example the block object 106 may represent a bus, a core, a queue, an external interrupt mechanism, or any user defined component or activity of the digital system. The block object can contain internal logic activity. In this manner, the block object can alter system variables or parameters, initiate events, alter the settings of other block objects, to name just a few. The block object may be defined with delays. In this manner, the characteristics of low level or high level components can be simulated.

The event object 104 is a software module that is dynamically interactive with the block objects depicted. In this manner the event object may “spark” any functionality of the associated block object. In this manner, a digital system can be modeled.

In particular the event object 102 contains a queue. This queue contains an indication of the specific blocks that it is to interact with. As pictured, the event object 102 is targeted to interact with the block object A first, then the block object b. Thus, the interaction of the block objects with the event simulates the full digital system.

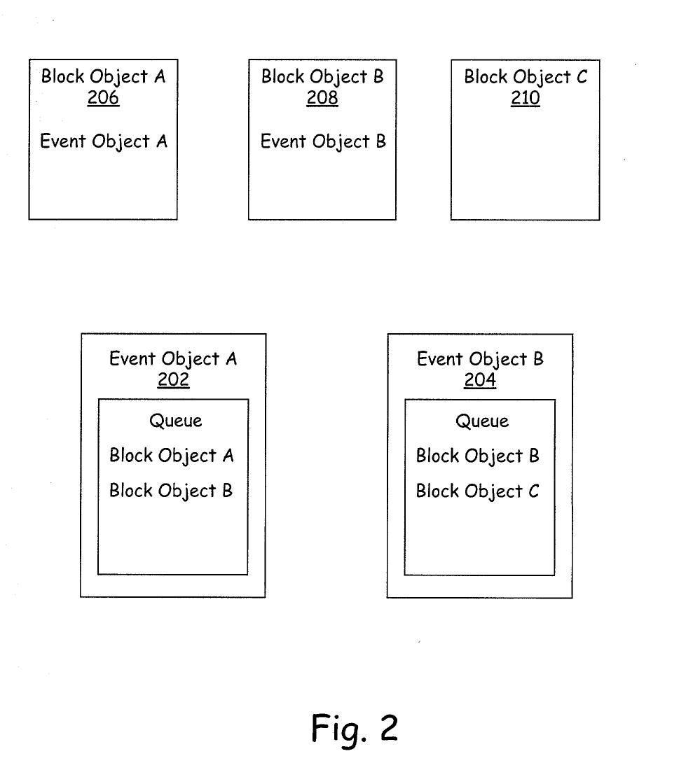

FIGS. 2-4 depict an embodiment of the simulator of FIG. 1. In this case, the simulator initiates the event objects 202 and 204. The event object 202 contains in its block queue an indication to interact with a block object 206 and a block object 208, respectively. Correspondingly, the event object 204 contains in its block queue an indication to interact with a block object 208 and a block object 210, respectively. At the initiation of the simulation, the block objects 206, 208, and 210 are initialized. Thus, the block object 206 contains an indication that the event object 202 is being responded to, and the block object 208 contains an indication that the event object 204 is being responded to.

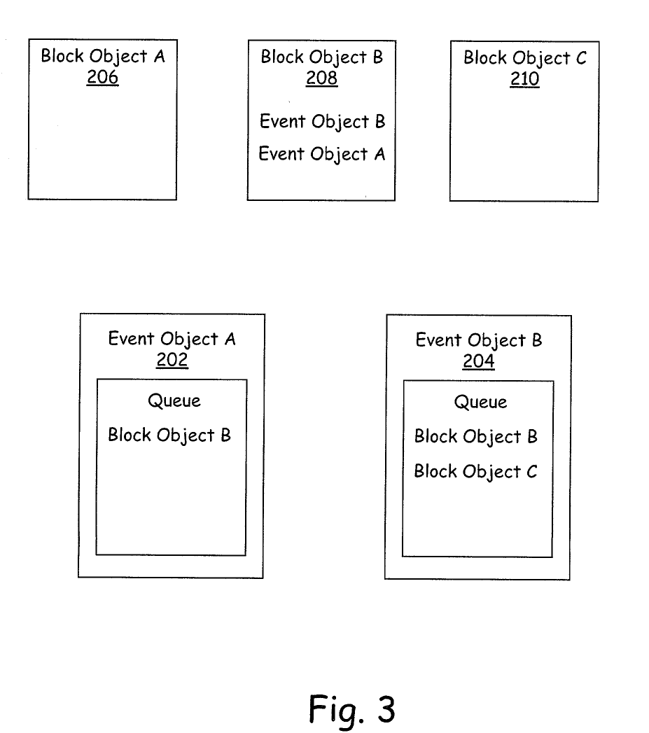

In FIG. 3, the block object 206 has performed the logical operation required, and all delays associated with the block object 206 have been met. The event object 202 has been released from the consideration of the next operation step to the block object 206. Additionally, the event object 202 has indicated itself that the block object 206 is not relevant to its continued journey. The event object 202 then determines that the next relevant interaction that it has is with the block object 208.

However, the event object 204 has not finished it interaction with the block object 208. Thus, the block object 208 is altered to show that the next action it responds to is the event object 202.

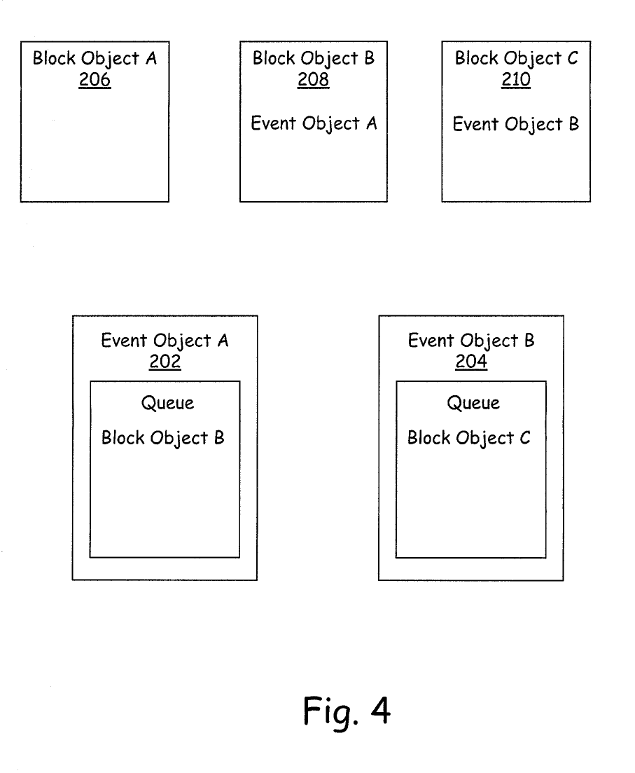

In FIG. 4, the block object 208 has finished its interaction with the event object 204. In the same manner as described above, the event object 204 is released from consideration by the block object 208, and correspondingly, the event object 204 is altered to indicate that it need not interact with the block object 208. In this manner, the block object 208 will initiate actions in response to the event object 202, and the block object 210 will initiate action with the event object 204 at the next clock cycle.

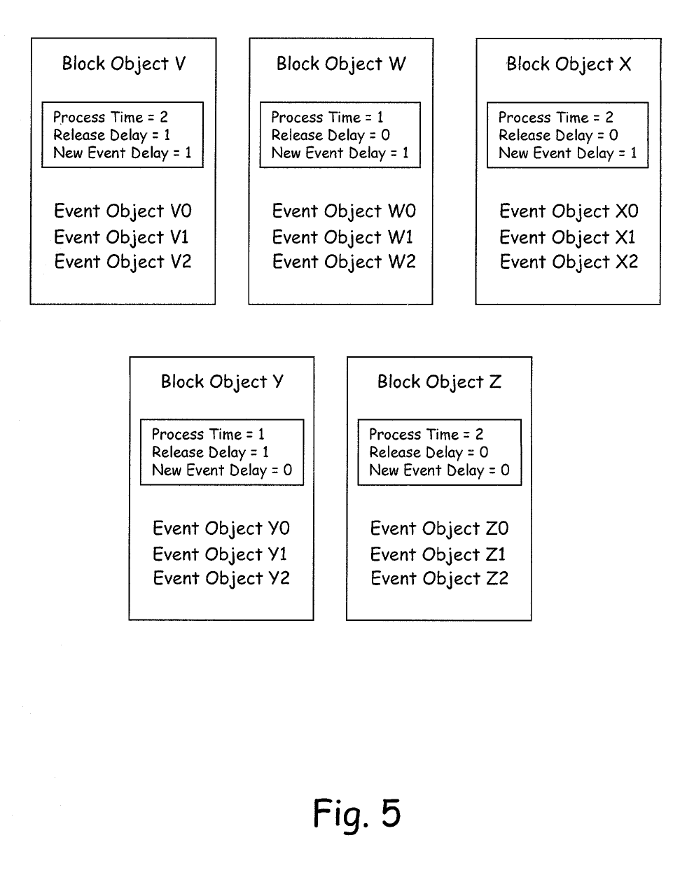

FIG. 5 is a block object oriented diagrams detailing the timing characteristics of various block diagrams. In this case, assume that 5 different block objects are present. Specifically, a block object V, a block object W, a block object X, a block object Y, and a block object Z have been defined in the system.

The block object Y has been defined as having a process time of 2 cycles, a release delay of 1 cycle, and a delay of 1 cycle in responding to any new request. Of course, many other characteristics of the component may be defined. The block object W has been defined as having a process time of 1 cycles, no release delay, and a delay of 1 cycle in responding to any new request. The block object X has been defined as having a process time of 2 cycles, no release delay, and a delay of 1 cycle in responding to any new request. The block object Y has been defined as having a process time of 1 cycles, a release delay of 1 cycle, no delay in responding to any new request. The block object Z has been defined as having a process time of 2 cycles, no release delay, and no delay in responding to any new request. Each block has multiple events defined to be processed, and the initial events are all assumed to have the start of the event at the same time for purposes of this diagram.

TABLE A

| | Object V | Object W | Object X | Object Y | Object Z |
|---|---|---|---|---|---|
| Cycle 1 | V0 | W1 | X0 | Y0 | Z0 |
| | (PR = 1) | (NE = 1) | (PR = 1) | (RD = 1) | (PR = 1) |
| Cycle 2 | V0 | W1 | X1 | Y1 | Z1 |
| | (RD = 1) | (PR = 1) | (NE = 1) | (PR = 1) | (PR = 2) |
| Cycle 3 | V1 | W2 | X1 | Y1 | Z1 |
| | (NE = 1) | (NE = 1) | (PR = 2) | (RD = 1) | (PR = 1) |
| Cycle 4 | V1 | W2 | X1 | Y2 | Z2 |
| | (PR = 2) | (PR = 1) | (PR = 1) | (PR = 1) | (PR = 2) |
| Cycle 5 | V1 | | X2 | Y2 | Z2 |
| | (PR = 1) | | (NE = 1) | (RD = 1) | (PR = 1) |
| Cycle 6 | V1 | | X2 | | |
| | (RD = 1) | | (PR = 2) | | |
| Cycle 7 | V2 | | X2 | | |
| | (NE = 1) | | (PR = 1) | | |

Table A, above, shows the timing characteristics of the system of block objects processing the respective event objects as described in FIG. 5. In this table, PR=Processing, RD=Release Delay, NE=New Event Delay. At the first cycle, the block object V processes the event. However, at time 2 the block V cannot release the event due to the presence of a release delay. On the third cycle, the block object V releases its first event, and prepares the new event to be processed.

However, the block object V has another response delay of one cycle, in which time the new event simply waits the proper delay to be serviced. On the fourth and fifth cycles, the second event present in the block object V is serviced. On the sixth cycle, the event has been serviced, but like the first event, must wait to be released.

The block object W has a different operational characteristic, based on different delay characteristics. On the first cycle, the first event in the block object W is processed, and since there is no release delay, the first event serviced by the block object W is released. The second event processed by the block object W is set to await the interaction with the block object W. However, the block object W has a delay before it can service the second event. On the second cycle, the second event for the block object W is serviced. Succeeding new event objects are serviced in this manner based on the characteristics of the block object.

The block object X, the block object Y, and the block object Z, are all diagrammed in a similar manner. The block objects X, Y, and Z each show different timing interactions based on characteristics defined at the block.

Of course other timing characteristics may be defined, based on the specific component. Some components may allow for immediate interrupts and rescheduling. Other components may allow for interrupts, but may only service such interrupts in predefined windows. As such, many different schemes for component characteristics may be envisioned.

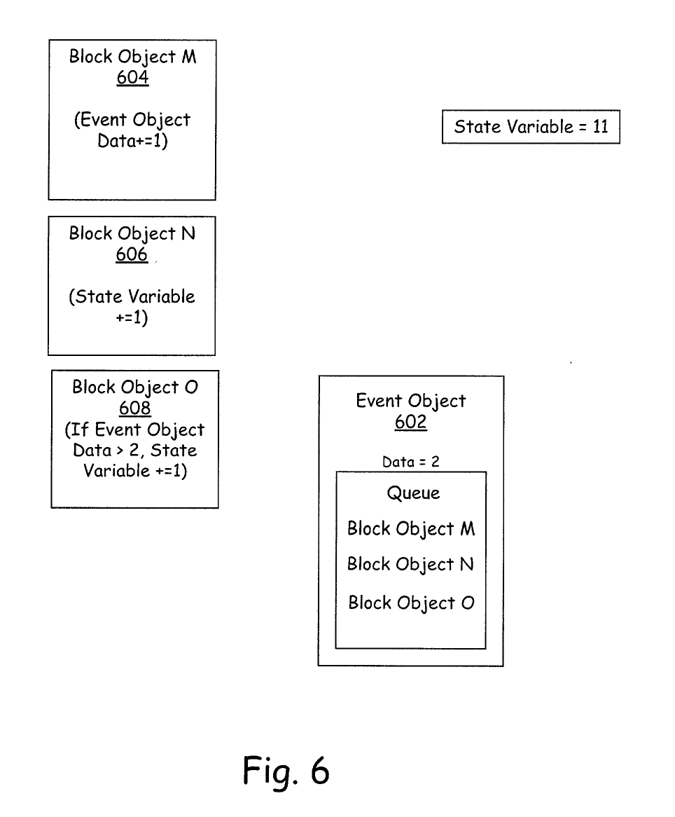

FIG. 6 is a block diagram detailing the interactions that event objects, block objects, and system wide values may have on one another. In this case an event object 602 is specified to interact with the block objects 604, 606, and 608, in order. In this case, assume that a particular variable in the event object 602 has a value of 2, and a state variable has a value of 11. In the first interaction, that with the block object 604, the block object alters the data associated with the event object 602 in some fashion. In particular, the block object increments the data field by 1. When the block object 604 releases the event object, the data field should reflect the change associated with the interaction.

Next, the event block will interact with the block object 606. In this case, the associated logic affects a state variable. In other cases, interactions can affect data associated with the block object, rather than the event object or state variable. Or, logical tests may be performed on inherent data, state variables, types of interactions, types of block objects, or types of event objects, such as that depicted with the block object 608. Of course, the functionality could reside either in the event object or block object, or some combination.

In particular, the event object may be predefined with a specific destination order. In this case, the event object would be instantiated, and the specific destinations would be added to the queue. Thus, the particular event path could be completely defined prior to the execution of the event. Or, the interactions can be used to dynamically vary the path.

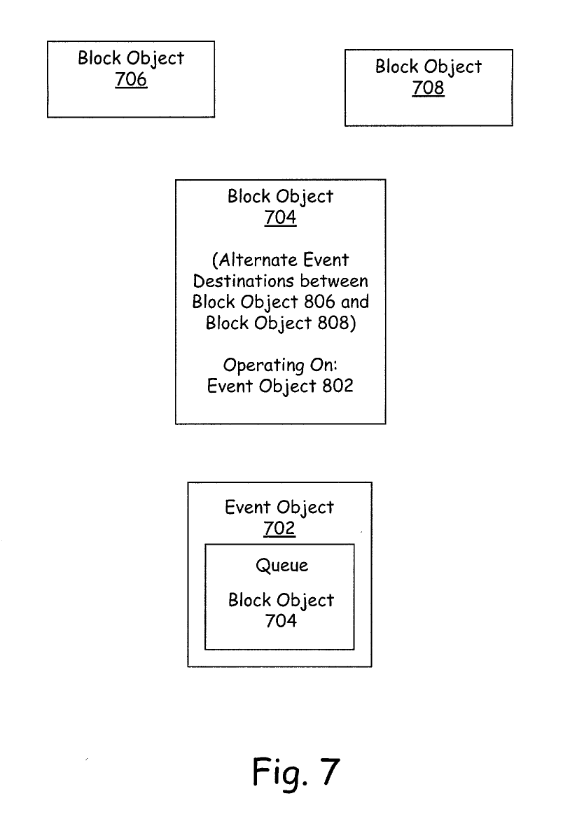

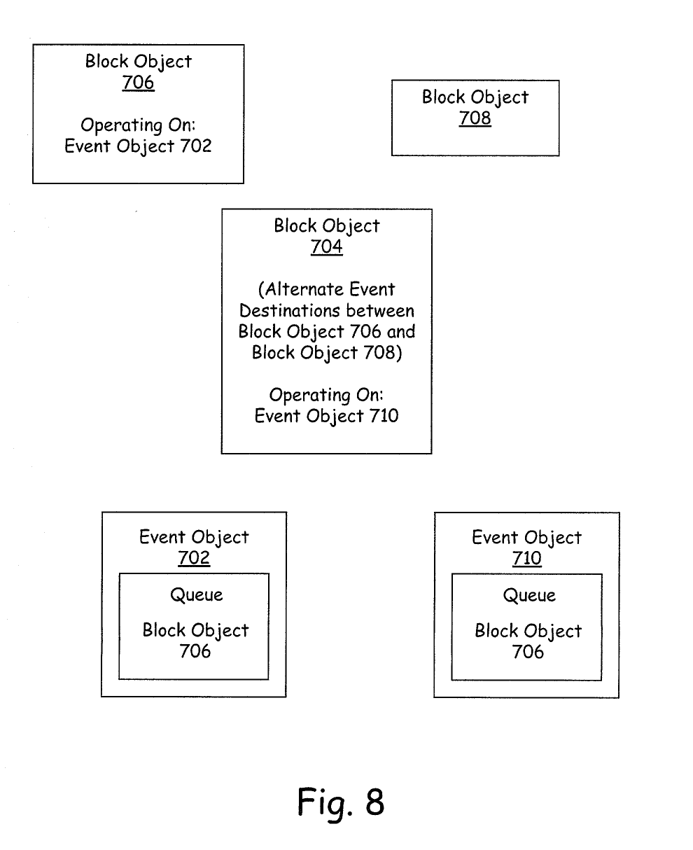

FIGS. 7 through 9 are a block level diagrams of another embodiment of the system of FIG. 1. The event object 702 is a specific list of destinations. In particular, the destinations could be indicative of a specific path that the event should take through the particular digital system. The destinations could include units for prefetching data, instruction pipeline, and cache determination units, to name but a few. Assume that the destination of the block object 704 is, in actuality, some type of branching block. For example, the block object 704 may be indicative of a component that sends instructions to one of several parallel functional units. In this case, the block object 704 could insert alternative destinations into the event object 702. In this case assume that the algorithm calls for straight alternate branching.

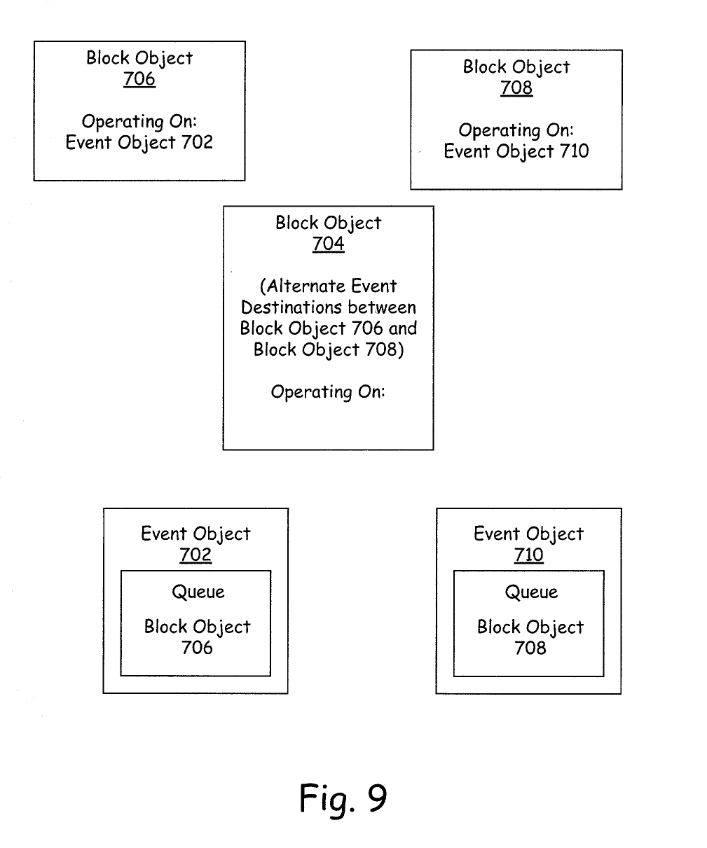

In processing the event object 702, the block object 704 then directs the event object 702 to the first branch block object 706. This is accomplished by inserting a new destination in the event object queue. This is diagrammed in FIG. 9.

The event object 702 then goes to the appropriate block object. In this case, the block object can dynamically alter the destination of the event. In this manner, the dynamic nature of the component can be translated into the simulation without a great deal of recoding. As such, the events may be modeled as accurately in the dynamic propagation as possible or necessary. In this manner, highly complex behavior in the system can be obtained without the same complexity as normal.

Continuing with the example, the next event object, specifically another event object 710, is then redirected to the other parallel unit. This is diagramed in FIG. 9. One should note that the specific logical redirection might be obtained for any digital behavior. For example, the redirection is not necessarily obtained through simple algorithms, but highly complex look-ahead and prefetch behavior can be modeled through this dynamic redirection.

Additionally, the redirection need not be additive in nature. This means destinations may be selectively or dynamically removed. Assume that an event is specified by the queue to have a certain action taken. Assume that the action is comparable to the instruction awaiting data from a slow memory, and after the appropriate information has been sent to the cache and, in parallel, to the main memory or readable medium for a prefetch. If the cache returns a hit, which could be modeled as the arrival of another event, or the change of a variable, the event may be flushed from the current block object. Or, other contingent block objects representing a predicted behavior can be remodeled. In this manner, highly complex interactions between components and events may be modeled on the most complex scales.

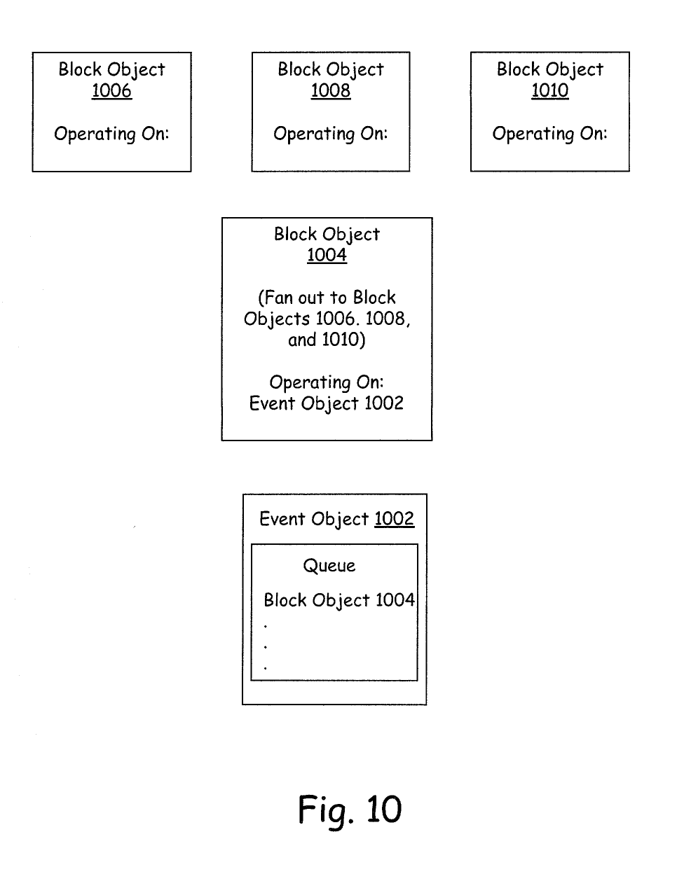

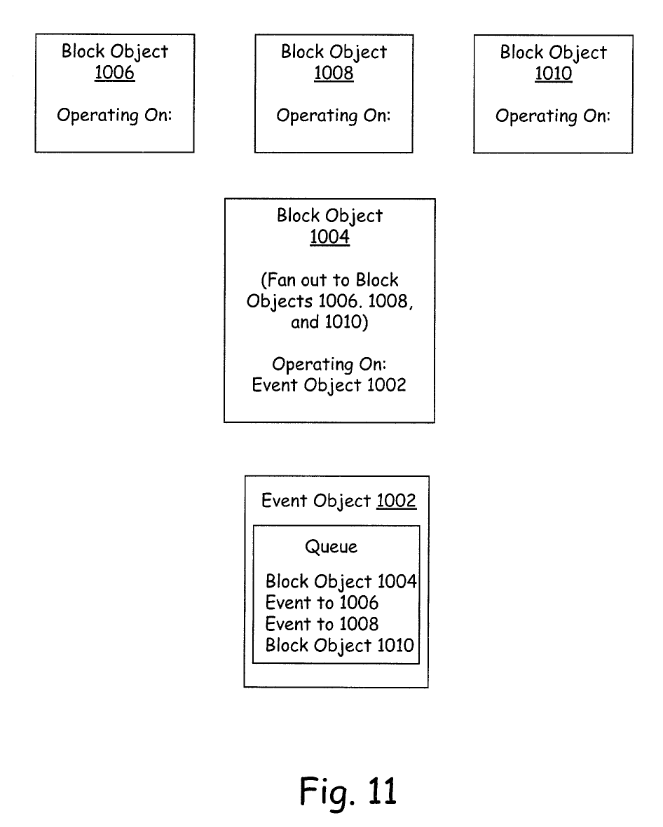

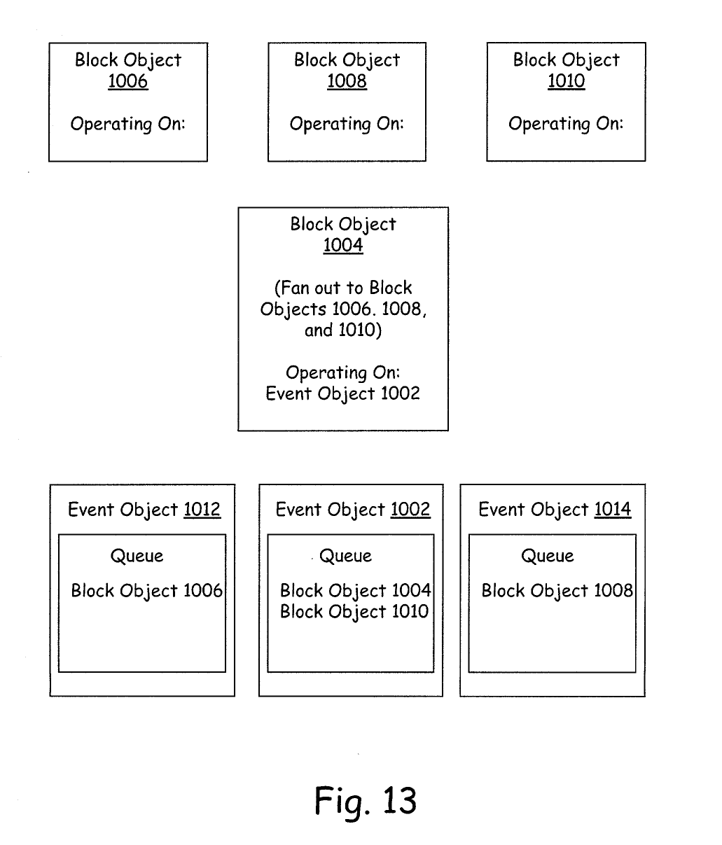

FIGS. 10 through 14 are block diagrams indicating another aspect of the invention of FIG. 1. In this case, the destinations of the event objects need not be solely block objects. In FIG. 10, assume that the event object 1002 is propagated to the block object 1004. The block object 1004 is indicative of the front end of a parallel component; that is, the component can send the same event to multiple destinations for a response. In operation, this is much like a cache request among a parallel microprocessor system, where each other processor needs to know of the request.

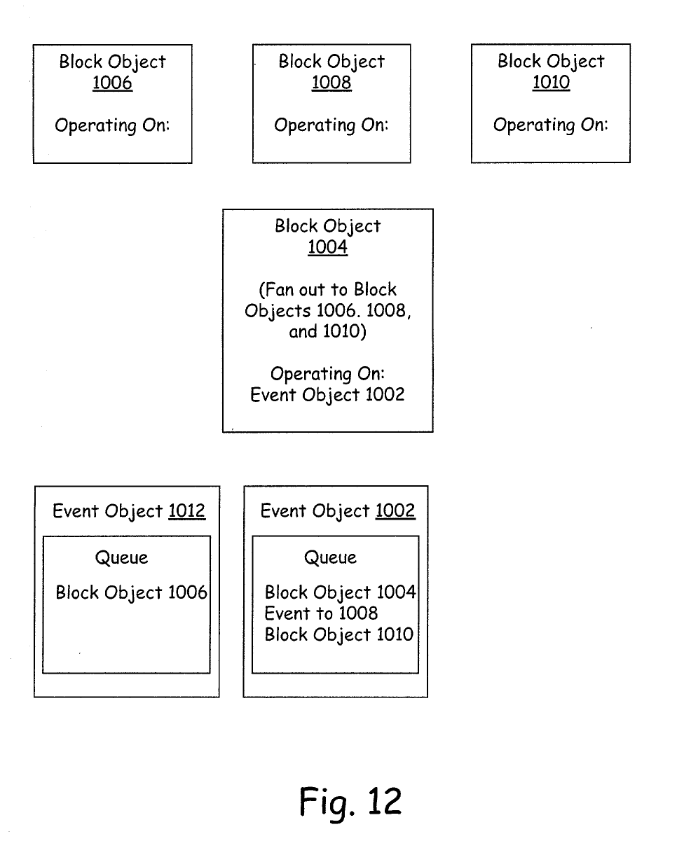

Assume that the alternative paths are represented by the block objects 1006, 1008, and 1010. In this case, the path of the event object 1002 may contain, or be altered, to contain several other event objects to be sent out. Thus, before the virtual execution of the event object 1002, the path for the event object 1002 could contain other indications of other event objects. In this case, the propagation is to be among three different paths, so two other event objects are specified in the destination queue. This is diagrammed in FIG. 12.

In FIG. 12, the path of the event object 1002 has been found to have another event object. Thus the event object 1012 is initiated with a path indicative of one of the alternative paths.

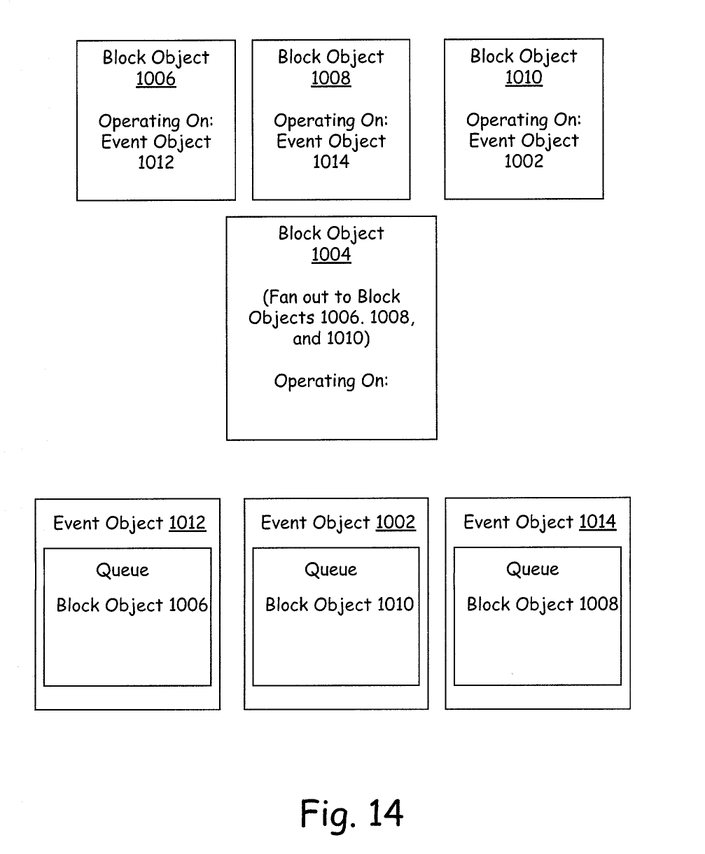

In FIG. 14, the next destination of the event object 1002 is yet another event object. Again, an event object 1014 is initiated with yet another path. Typically, these “spawn events” can be modeled so that no “virtual cycles” have ticked off—they are zero time events. Or, depending on the components involved, they may be modeled as positive time events.

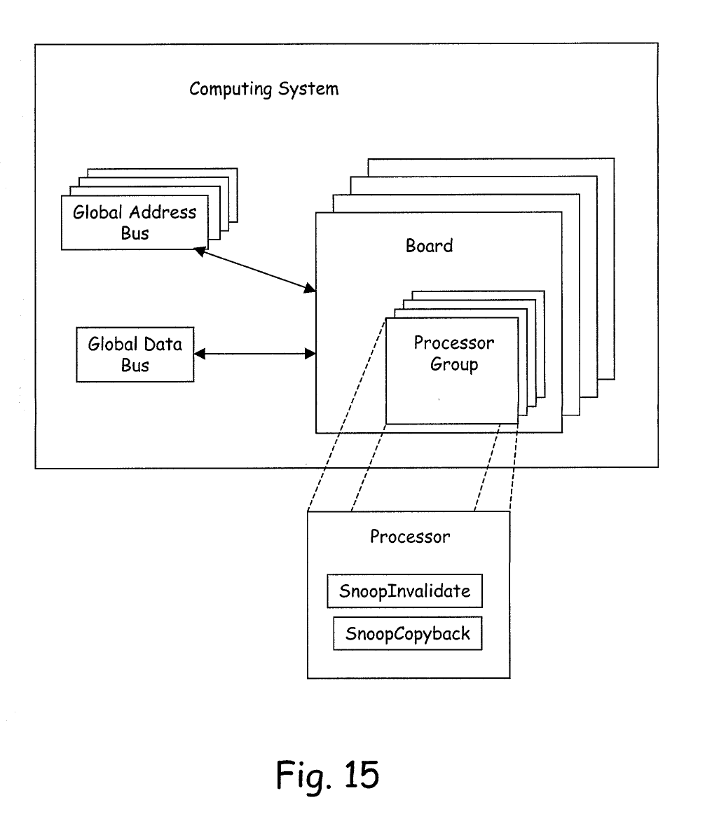

In FIG. 15, the three different events are headed to its particular block object destination. Communication between the various block objects or other events can be used to “kill” these fan-out events. Or, if necessary, specific “zero-time” block objects may be implemented to determine when some threshold regarding the fanned out events has occurred.

The same fan-out behavior may be used to model a single event that initiates several other events, but not in the parallel sense. For example, such fan-out events may be the receipt of an instruction, with simultaneous events sent to both the cache and main memory. Or, assume that a certain event will cause simultaneous repercussions in several components. This may occur due to an interrupt or some other event.

FIG. 16 is an exemplary implementation of a high level simulation of a multi processor, multi-bus system that can be simulated with the present invention. In particular the specific computing system may be modeled as several block objects. In the lower portion of FIG. 16, a high level implementation of a single processor is modeled. The implementation may be with the block object, with the appropriate logical connections and delays.

At the next level, a board containing multiple processors can also be modeled. Additionally multiple boards may be modeled in the same way.

Further, a multi-bus global address bus system (Gab) is modeled through the use of the block objects, each representing on of the buses. Further, a global data bus is modeled through the use of a block object. In this manner, the highly complex interactions of the microprocessor system can be easily simulated.

The following code segment is a specific encoding of the Snoop invalidate functionality of the microprocessor depicted in FIG. 15.

public Block snoopInval = new Block() {

{setString (“Snoop Invalidate”); }
public void program (InvokeEvent e) {

e.add (Queue.delay(1)); // cpu thinks
e.add (12Dir); // read
e.add(12Dir); // write

}

}

In this case, the event has specific delays placed into the queue, as well as specific functional specifications.

The following code segments show specific testing situations that enables the specific testing sequence. Notice in the case of the second code segment, in that the system changes the timing of the sequence in the manner in which the event is added to the queue.

$Path = \{ \frac{q1 , q2 , q4 if test is true ,}{q1 , q3 , q4 otherwise}$
Queue q1 = new Queue (1, “Queue One”);
Queue q2 = new Queue (1, 2, “Queue Two”);
Queue q3 = new Queue (1, 3, “Queue Three”);
Queue q4 = new Queue (2, “Queue Four”)’
public class MyBlock extends Block {

public void program (InvokeEvent e) {

e.add (q1);
if (test( )) e.add(q2);
else e.add (q3);
e.add (q4);

$Path = \{ q1 \} , \{ \frac{q2 if test is true ,}{q3 otherwise .} \} , \{ q4 \}$
Queue q1 = new Queue (1, “Queue One”);
Queue q2 = new Queue (1, 2, “Queue Two”);
Queue q3 = new Queue (1, 3, “Queue Three”);
Queue q4 = new Queue (2, “Queue Four”);
Public class MyBlock extends Block {

Public void program (InvokeEvent e) {

e.add (q1);
e.add (new Block( ) {

public void program (InvokeEvent e) {

if (test( )) e.add(q2);
else e.add(q3);

}

{);
e.add(q4);

}
}

The following code segment details the simulating the spawning of parallel events. This occurs in the context of a background store, where the store can take place at the same time that other events can occur that are relevant to the system being depicted.

case 1;

12hit(e);
break;

default: // background store

CacheEvent store = new CacheEvent(e);
12hit (store);
e.add(store);

}

In particular, the event objects and the block objects as described are implemented in an object oriented environment. This environment may be monolithic in nature or each specific event object or block object may exist as independent persistent objects which interact, rather than run as part of a program. Additionally, the objects can take the form of an object implemented in a run time system, such as Java®. In this case, the execution of the object takes place automatically without specific invocation. Additionally, the single computing system depicted in FIG. 1 need not be a single system, but may take the form of several interconnected systems, each containing one or more of the objects.

Of course, the specific simulation need not take place at such a highly defined level. Any particular the simulation scope can be increased or decreased to any desired level with relatively little impact on the building blocks, namely the event objects and the block objects, and their interactivity with themselves and each other.

The invention may be embodied on any computing device or software that runs on a computer. It may be embodied in any combination of software or hardware, including running instructions from any computer readable medium.

Thus, a method and apparatus for modeling digital systems is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

I claim:

1. A digital logic circuit simulator comprising:
a block object, the block object representing a component of the digital logic circuit; and
an event object having a queue, the queue holding an ordered list of destinations, said destinations representative of the block objects with which the event object initiates an action, the event object interacting with the block object and initiating behavior in the block object indicative of behavior of the component.

2. The digital logic circuit simulator of claim 1 wherein the block object is instantiated in a run-time object oriented language.

3. The digital logic circuit simulator of claim 2 wherein the language is JAVA.

4. The digital logic circuit simulator of claim 1 wherein the block object initiates a dynamic addition to the destination queue.

5. The digital logic circuit simulator of claim 1 wherein the destination comprises another event object.

6. The digital logic circuit simulator of claim 1 wherein when the destination comprises another event object, the action undertaken is to initiate another event object.

7. The digital logic circuit simulator of claim 1 wherein another event object is dynamically created within the instructions of adding to the destination queue to test for the existence of a particular condition.

8. The digital logic circuit simulator of claim 1 wherein when the event object can alter a condition of the block object.

9. The digital logic circuit simulator of claim 1 wherein when the block object can alter a condition of the event object.

10. The digital logic circuit simulator of claim 1 wherein when the block object represents an interrupt.

11. A digital logic circuit simulator comprising:
a means for representing a component of the digital logic circuit;
a means for representing an event, the means for representing an event having a queue, the queue holding an ordered list of destinations; and
the destinations representative of objects that the means for representing an event initiates an action with, the means for representing an event interacting with the means for representing a component and initiating behavior in the means for representing a component indicative of behavior of the component.

12. The digital logic circuit simulator of claim 11 wherein the means for representing a component is instantiated in a run-time object oriented language.

13. The digital logic circuit simulator of claim 12 wherein the language is JAVA.

14. The digital logic circuit simulator of claim 1 1 wherein the means for representing a component initiates a dynamic addition to the destination queue.

15. The digital logic circuit simulator of claim 11 wherein the destination comprises another means for representing an event.

16. The digital logic circuit simulator of claim 11 wherein when the destination comprises another means for representing an event, the action undertaken is to initiate another means for representing an event.

17. The digital logic circuit simulator of claim 11 wherein another means for representing an event is dynamically created within the instructions of adding to the destination queue to test for the existence of a particular condition.

18. The digital logic circuit simulator of claim 11 wherein when the means for representing an event can alter a condition of the means for representing a component.

19. The digital logic circuit simulator of claim 11 wherein when the means for representing a component can alter a condition of the means for representing an event.

20. The digital logic circuit simulator of claim 1 wherein when the means for representing a component represents an interrupt.

21. A digital logic circuit simulator comprising:
instructions on a machine readable medium, the instructions indicative of the machine performing particular actions, the instructions comprising:
instructions for representing a component of the digital logic circuit;
instructions for representing an event, the means for representing an event having a queue, the queue holding an ordered list of destinations; and
the destinations representative of objects that the instructions for representing an event initiates an action with, the instructions for representing an event interacting with the instructions for representing a component and initiating behavior in the instructions for representing a component indicative of behavior of the component.

22. The digital logic circuit simulator of claim 21 wherein the instructions for representing a component are instantiated in a run-time object oriented language.

23. The digital logic circuit simulator of claim 22 wherein the language is JAVA.

24. The digital logic circuit simulator of claim 21 wherein the instructions for representing a component initiate a dynamic addition to the destination queue.

25. The digital logic circuit simulator of claim 21 wherein the destination comprises another instructions for representing an event.

26. The digital logic circuit simulator of claim 21 wherein when the destination comprises another instructions for representing an event, the action undertaken is to initiate another instructions for representing an event.

27. The digital logic circuit simulator of claim 21 wherein another instructions for representing an event is dynamically created within the instructions of adding to the destination queue to test for the existence of a particular condition.

28. The digital logic circuit simulator of claim 21 wherein when the instructions for representing an event can alter a condition of the instructions for representing a component.

29. The digital logic circuit simulator of claim 21 wherein when the instructions for representing a component can alter a condition of the instructions for representing an event.

30. A method for simulating a digital logic circuit simulator, the method comprising:
initiating a block object, representative of a component of the digital logic circuit;
initiating an event object, representative of an event in the digital logic circuit, the event object having a queue, the queue holding an ordered list of destinations;
initiating an interaction between the event object and the various destinations contained in the queue, the interaction representative of behavior of the particular destination in light of the event object.

31. The method of claim 30 wherein the step of initiating the block object is performed through using a run-time object oriented language.

32. The method of claim 31 wherein the language is JAVA.

33. The method of claim 30 further comprising:
initiating a dynamic addition to the destination queue with an interaction with the block object.

34. The method of claim 30 wherein the destination comprises another event object

35. The method of claim 34 further comprising:
initiating another event object when the destination is an event object.

36. The method of claim 30 further comprising:
in the block object, testing the existence of a particular condition; and
dynamically creating another event object based upon the results of the test.

37. The method of claim 30 further comprising:
altering conditions of the block object, based in the step of initiating an interaction.

38. The method of claim 30 further comprising:
altering conditions of the event object, based in the step of initiating an interaction.

39. A digital logic circuit simulator comprising:
a plurality of block objects, at least one of the block objects representing a component of the digital logic circuit;
an event object having a queue, the queue holding an ordered list of destinations, the destinations representative of block objects that the event object initiates an action with; and
the event object queue dynamically interactive with at least one of the block objects, allowing the event object behavior to be modified with such dynamic interaction.

40. A computing system simulator comprising:
a state space variable, representing at least one parameter associated with the computing system;
a block object, representing a component of the computing system;
an event object, operable to maintaining a list of destination blocks;
the state space variable, the block object, and the event object all communicatively coupled with one another;
the event object interacting with the block object based on the operation of the list of destination blocks.

41. An event block used in a simulation of a computing system, the event block comprising:
a queue of entries, each entry representative of one or more destination blocks, wherein the execution associated with each of the destination blocks is indicative of a first action of the simulated operation of the computing system;
any one of the destination blocks representing another event block, wherein the execution associated with the another event block is indicative of a second action of the simulated operation of the computing system; and
the first action and the second action are simulated as concurrent actions.

42. An event block used in a simulation of a computing system, the event block comprising:
a queue of entries, each entry representative of one or more destination blocks, wherein the execution associated with each of the destination blocks is indicative of a first action of the simulated operation of the computing system;
any one of the destination blocks operable to be altered during the execution of the event block; and
the alteration operable in response to the state of any of the following: another event block, a component block, or a parameter associated with the simulation of the computer system.
